(19) United States
(12) Patent Application Publication
(10) Pub. No.: US 2024/0424646 A1
(43) Pub. Date: Dec. 26, 2024

(54) DIGITAL DISPLAY SUCTION CUP

(71) Applicant: Jianchang Liu, Shangrao (CN)

(72) Inventor: Jianchang Liu, Shangrao (CN)

(21) Appl. No.: 18/337,805

(22) Filed: Jun. 20, 2023

(51) Int. Cl. B25B 11/00

(52) U.S. Cl. CPC B25B 11/007

(57) ABSTRACT

Disclosed is a digital display suction cup, comprising a suction cup and a handle structure, wherein the two ends of the handle structure are provided with a switch button and a pressure relief valve, and the handle structure is provided with a battery and a vacuum electric pump; the vacuum electric pump is connected to the suction cup through an air pipe; the lower part of the battery end of the handle structure is provided with an air pressure sensor and a display screen; the air pressure sensor, display screen, switch button, battery, and electric vacuum pump are electrically connected. The new type of digital display suction cup adopts button operation and automatic vacuuming, which can monitor and maintain negative pressure in real time, and the power and negative pressure data can be observed; the suction cups can also be used in combination.

### 1. TECHNICAL FIELD

The invention relates to the technical field of new type of digital display suction cups, in particular to a new type of digital display suction cup.

### 2. BACKGROUND ART

In the existing production of industrial glass, stone and other plates, suction cups are needed when handling or moving the plates. Patent CN210192766U discloses a suction cup for industrial glass production, comprising a fixing plate and a fixing bracket; the top of the fixing plate is fixed with a fixing bracket by bolts, and the right side of the fixing bracket is fixed with a control module by bolts; the bottom end of the fixing plate is fixedly provided with buckles; the bottom end of the fixing plate is movably connected with a plastic vacuum suction cup, and the upper surface opening of the plastic vacuum suction cup is provided with a groove; the inside of the plastic vacuum suction cup is fixed with a shaping steel wire; a ventilation device is fixedly installed inside the fixing plate, and the ventilation device comprises a gas valve, an exhaust nozzle and an air connection pipe; the bottom end of the air valve is fixed with an exhaust nozzle through bolts, and the top end of the air valve is fixed with an air pipe through bolts. The suction cup can absorb the glass by pressing, and the operation is simple; however, there are few functions, and it is impossible to monitor the internal negative pressure in real time, and it is also unable to automatically maintain the negative pressure; if the moving distance is long, air leakage will easily occur, and the adsorption force will become smaller, causing the board to fall off and break through during transportation, causing unnecessary losses; in addition, most existing suction cups can only be used by hand alone.

### 3. SUMMARY OF THE INVENTION

The technical problem to be solved by the invention is to overcome the defects of the above technologies and provide a new type of digital display suction cup.

In order to solve the above technical problems, the invention provides a new type of digital display suction cup, comprising a suction cup and a handle structure, wherein the two ends of the handle structure are provided with a switch button and a pressure relief valve, and the handle structure is provided with a battery and a vacuum electric pump; the vacuum electric pump is connected to the suction cup through an air pipe; the lower part of the battery end of the handle structure is provided with an air pressure sensor and a display screen; the air pressure sensor, display screen, switch button, battery, and electric vacuum pump are electrically connected.

As an improvement, the suction cup and the handle structure are fixedly connected by bolts.

As an improvement, the pressure relief valve comprises a shaft, a spring, and an air pressure cover.

As an improvement, the display screen displays the negative pressure value of the suction cup and battery power.

As an improvement, the inner side of the suction cup is provided with an evacuation hole, a pressure relief hole, and a sensing through hole; the evacuation hole is communicated with the air pipe, the pressure relief hole is communicated with the pressure relief valve, and the sensing through hole is communicated with the air pressure sensor.

As an improvement, the switch button end of the handle structure is also provided with a USB charging port, and the USB charging port is electrically connected to the battery.

As an improvement, both sides of the handle structure are provided with four hanging holes in total.

The advantages of the invention compared with prior art are: the user holds the hand-held handle structure and presses the suction cup on glass and other plates, then presses the switch button, the vacuum electric pump starts vacuuming, and then the suction cup can be moved; the display screen shows real-time negative pressure and power; if the negative pressure changes beyond the micro-motion range during the period, the air pressure sensor triggers the signal, and the vacuum electric pump automatically starts vacuuming to maintain a high negative pressure state. After the moving operation is completed, press the switch button and the pressure relief valve to turn off the vacuum electric pump and leave the air pressure cover to release the pressure, and then the suction cup can be removed manually. Hanging holes can be used for connecting rods or pendants.

The new type of digital display suction cup adopts button operation and automatic vacuuming, which can monitor and maintain negative pressure in real time, and the power and negative pressure data can be observed; the suction cups can also be used in combination; at this time, the hanging holes are used for centralized suspension, which is convenient and safe to use, and is suitable for long-distance adsorption and movement, and has high practical value and promotion value.

### 4. BRIEF DESCRIPTION OF ACCOMPANY DRAWINGS

FIG. 1 is a first structural schematic diagram of the new type of digital display suction cup according to the invention.

FIG. 2 is a second structural schematic diagram of the new type of digital display suction cup according to the invention.

FIG. 13 is a third structural schematic diagram of the new type of digital display suction cup according to the invention.

FIG. 4 is a partial structural schematic diagram of the new type of digital display suction cup according to the invention.

FIG. 5 is a sectional view of the new type of digital display suction cup according to the invention.

FIG. 6 is a system schematic diagram of the new type of digital display suction cup according to the invention.

As shown in the figures, 1 refers to the suction cup; 2 refers to the handle structure; 3 refers to the switch button; 4 refers to the pressure relief valve; 5 refers to the vacuum electric pump; 6 refers to the air pipe; 7 refers to the air pressure sensor; 8 refers to the display screen; 9 refers to the shaft; 10 refers to the spring; 11 refers to the air pressure cover; 12 refers to the evacuation hole; 13 refers to the pressure relief hole; 14 refers to the sensing through hole; 15 refers to the USB charging port; 16 refers to the battery; 17 refers to the hanging hole.

### 5. SPECIFIC EMBODIMENT OF THE INVENTION

The new type of digital display suction cup according to the invention will be further described in detail hereinafter with reference to the drawings.

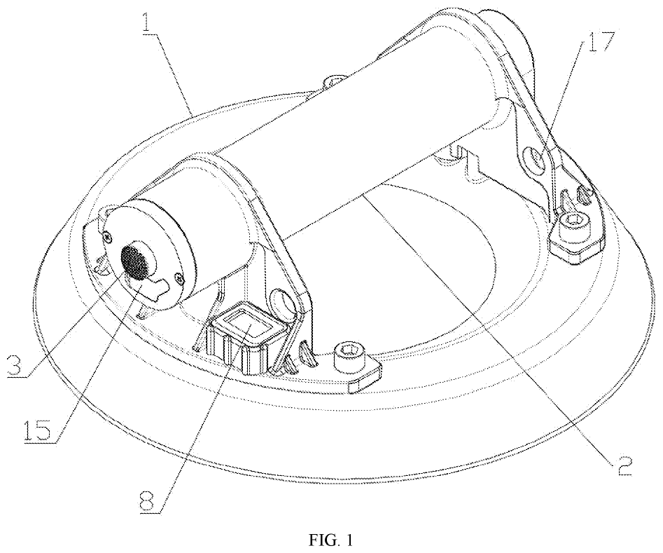

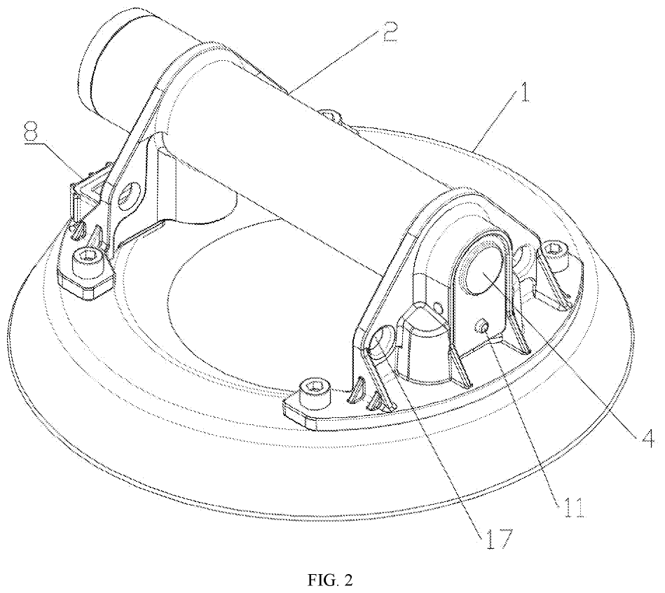

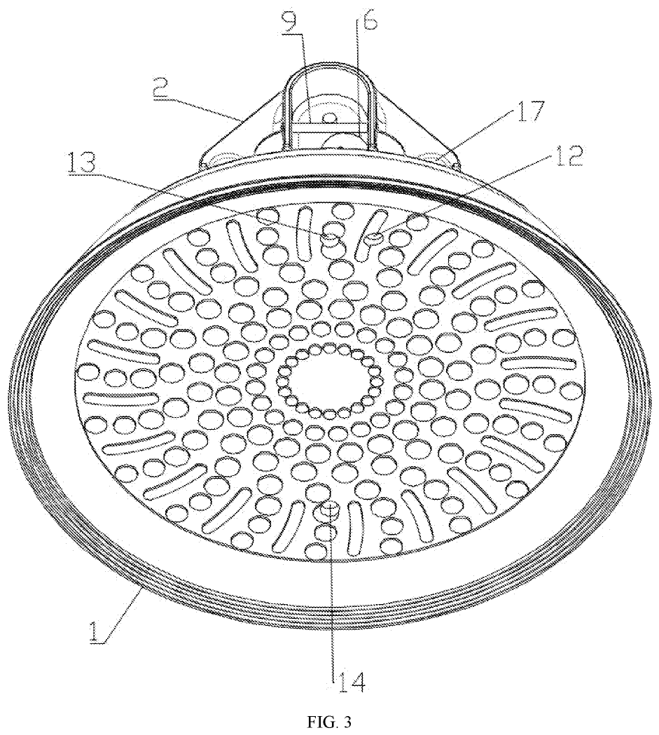

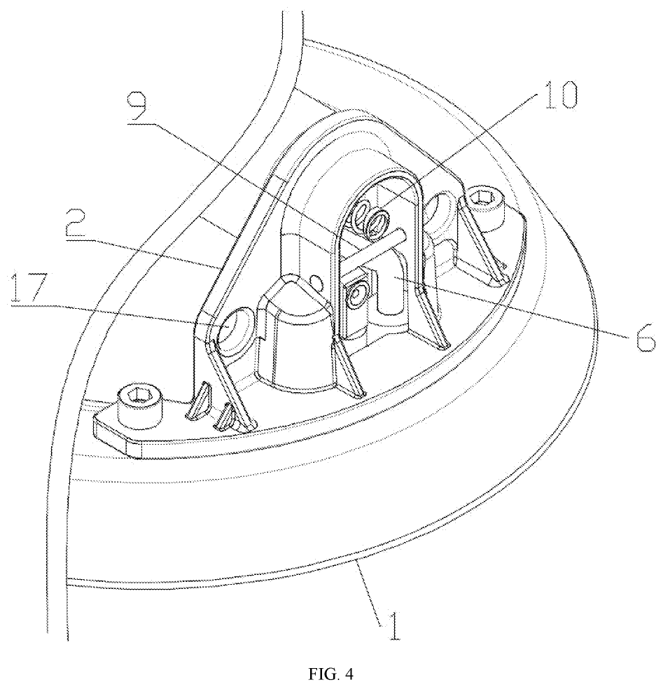

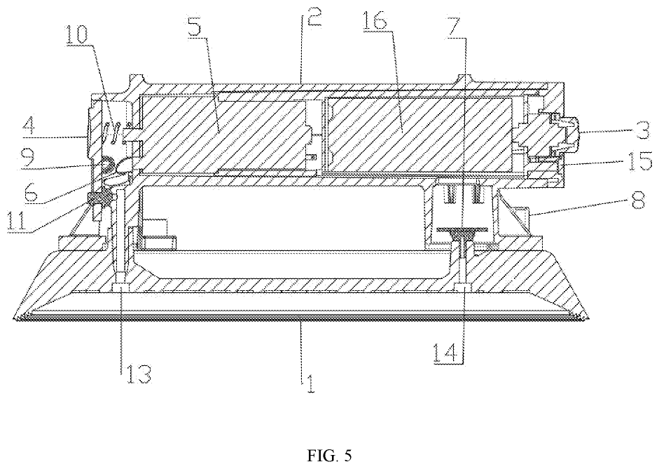

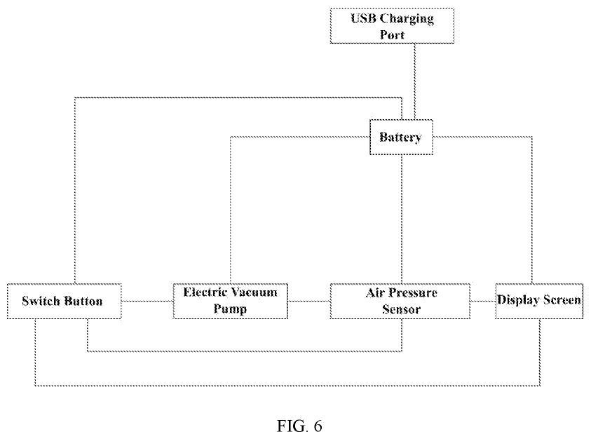

With reference to FIGS. 1-6, new type of digital display suction cup, comprising a suction cup 1 and a handle structure 2, wherein the two ends of the handle structure 2 are provided with a switch button 3 and a pressure relief valve 4, and the handle structure 2 is provided with a battery 16 and a vacuum electric pump 5; the vacuum electric pump 5 is connected to the suction cup 1 through an air pipe 6; the lower part of the battery 16 end of the handle structure 2 is provided with an air pressure sensor 7 and a display screen 8; the air pressure sensor 7, display screen 8, switch button 3, battery 16, and electric vacuum pump 5 are electrically connected.

The suction cup 1 and the handle structure 2 are fixedly connected by bolts.

The pressure relief valve 4 comprises a shaft 9, a spring 10, and an air pressure cover 11.

The display screen 8 displays the negative pressure value of the suction cup 1 and battery 16 power.

The inner side of the suction cup 1 is provided with an evacuation hole 12, a pressure relief hole 13, and a sensing through hole 14; the evacuation hole 12 is communicated with the air pipe 6, the pressure relief hole 13 is communicated with the pressure relief valve 4, and the sensing through hole 14 is communicated with the air pressure sensor 7.

The switch button 3 end of the handle structure 2 is also provided with a USB charging port 15, and the USB charging port 15 is electrically connected to the battery 16.

Both sides of the handle structure 2 are provided with four hanging holes 17 in total.

When the invention is in specific implementation, the user holds the hand-held handle structure 2 and presses the suction cup 1 on glass and other plates, then presses the switch button 3, the vacuum electric pump 5 starts vacuuming, and then the suction cup 1 can be moved; the display screen 8 shows real-time negative pressure and power; if the negative pressure changes beyond the micro-motion range during the period, the air pressure sensor 7 triggers the signal, and the vacuum electric pump 5 automatically starts vacuuming to maintain a high negative pressure state. After the moving operation is completed, press the switch button 3 and the pressure relief valve 4 to turn off the vacuum electric pump 5 and leave the air pressure cover 11 to release the pressure, and then the suction cup 1 can be removed manually. The USB charging port 15 is used for charging the battery 16, and the hanging holes 17 can be used for connecting rods or pendants.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A digital display suction cup, comprising a suction cup and a handle structure, wherein the two ends of the handle structure are provided with a switch button and a pressure relief valve, and the handle structure is provided with a battery and a vacuum electric pump; the vacuum electric pump is connected to the suction cup through an air pipe; the lower part of the battery end of the handle structure is provided with an air pressure sensor and a display screen; the air pressure sensor, display screen, switch button, battery, and electric vacuum pump are electrically connected.

2. The digital display suction cup of claim 1, wherein the suction cup and the handle structure are fixedly connected by bolts.

3. The digital display suction cup of claim 1, wherein the pressure relief valve comprises a shaft, a spring, and an air pressure cover.

4. The digital display suction cup of claim 1, wherein the display screen displays the negative pressure value of the suction cup and battery power.

5. The digital display suction cup of claim 1, wherein the inner side of the suction cup is provided with an evacuation hole, a pressure relief hole, and a sensing through hole; the evacuation hole is communicated with the air pipe, the pressure relief hole is communicated with the pressure relief valve, and the sensing through hole is communicated with the air pressure sensor.

6. The digital display suction cup of claim 1, wherein the switch button end of the handle structure is also provided with a USB charging port, and the USB charging port is electrically connected to the battery.

7. The digital display suction cup of claim 1, wherein both sides of the handle structure are provided with four hanging holes in total.
